(19) United States
(12) Patent Application Publication
(10) Pub. No.: US 2024/0298691 A1
(43) Pub. Date: Sep. 12, 2024

(54) A POTATO-LIKE PRODUCT TO SUBSTITUTE POTATO PRODUCTS

(71) Applicant: INSULIN RESET APS, Arre (DK)

(72) Inventor: Angela Pereira da Rocha, Arre (DK)

(21) Appl. No.: 18/546,178

(22) PCT Filed: Feb. 16, 2022
(86) PCT No.: PCT/EP2022/053742

§ 371 Date: Aug. 11, 2023

(30) Foreign Application Priority Data
Feb. 16, 2021 (DK) PA 2021 00171

(51) Int. Cl. A23P 30/10; A23L 19/00; A23P 30/20

(52) U.S. Cl. CPC A23P 30/10; A23L 19/09; A23P 30/20

(57) ABSTRACT

A substitute food product for potatoes is made of fresh plantain and/or green banana, and a production process for such a product is shown.

### TECHNICAL FIELD OF THE INVENTION

The present invention relates to a substitution food for potatoes (including directly derived products) made of green plantain, green banana, or the like and a production process for such a product.

### BACKGROUND OF THE INVENTION

The obesity is on the rise globally. Different products and diet strategies has emerged to try to address the problem. Several products have been made with the use of konjac fibres. However, the texture, smell, and taste cannot be compared to an actual potato. The most challenging aspect of the problem is to change the long-term eating habits, which is difficult due to inherent of human behaviour. Therefore, the development of a product that could have similar organoleptic characteristics to an actual potato is a key to change the long-term eating habits.

It is therefore desirable to provide a product, which can eliminate some or all of the above problems.

### DESCRIPTION OF THE INVENTION

To tackle the problem, the inventor has developed a potato-like product, which resembles an actual potato product, such that a user can consume a reduced glycemic index product for a longer period and obtain a healthier diet. The inventor has found that the use of green banana (including plantain and other fruits within the genus Musa) can solve the issue due to the similarities of colour, taste, smell, consistency, and texture.

For a given banana, each ripening stage can be correlated with its sugar content, which is defined herein as the percentage mass of sugars (sucrose, glucose, and fructose) of the total mass of that banana's pulp. For purposes of this disclosure: a Stage 1 banana has a sugar content of 2% or less; a Stage 2 banana has a sugar content greater than 2% up to and including 5%; a Stage 3 banana has a sugar content greater than 5% up to and including 10%; a Stage 4 banana has a sugar content greater than 10% up to and including 25%; a Stage 5 banana has a sugar content greater than 25% up to and including 45%; a Stage 6 banana has a sugar content greater than 45% up to and including 65%; and a Stage 7 banana has a sugar content greater than 65%. As used herein, the term “green banana” encompasses bananas that are in any of ripeness Stages 1, 2, 3, or 4 as defined herein. The term “green banana” further encompasses plantains having sugar content corresponding to that of any of ripeness Stages 1, 2, 3, and 4 defined herein, as plantains are very similar in composition of starch and proteins to green bananas.

A first aspect relates to a method for the production of a potato substitute food product comprising the steps of:
a) Combining 50-90% w/w of cooked green banana with 10-30% w/w water, and optionally 0-40% w/w of additives, such as flavourings, protein, starch, alpha-amylase inhibitor to form a first composition;
b) Mixing said first composition to form a first mixture;
c1) Filling said first mixture into a container or mould with the shape of a potato food product to form a potato substitute food product; or
c2) Extruding said first mixture into a container or mould with the shape of a potato food product to form a potato substitute food product, or extruding said first mixture directly into a form of a potato substitute food product; and
d1) Optionally, cooling or freezing said potato substitute food product; or
d2) Cooking, roasting, boiling, or frying said potato substitute food product.

In the present context, the term “cooling” refers to lowering the temperature to the desired temperature, such as within the range of 0-25 degrees Celsius, preferably within the range of 1-10 degrees Celsius.

In the present context, the term “freezing” refers to lowering the temperature to the desired temperature, such as within the range of −78-0 degrees Celsius, preferably within the range of −78 to −18 degrees Celsius.

It is increasingly acknowledged in the food industry that it is nutritionally desirable to preserve the complexity of any starch present, especially if this is in the form of so-called resistant starches that are not completely digested in the small intestines, as they have been associated with health benefits, such as prebiotic properties, and stable blood sugar levels. Plantain and green banana are known for their nutritional value due to their content of resistant starch. Furthermore, resistant starch is in general associated with a high content of amylose.

In order to obtain a product similar to an actual potato, a mixture of cooked green plantain or green banana is mixed with water, possible co-mixed with additives, such as another source of starch and/or protein, but preferably without. The water addition alters the starch in the cooked green plantain or green banana. Starch consists of two polymers—amylose, and amylopectin. The molar ratio can vary among different botanic sources but are typically 20-30% and 80-70%, respectively. It is speculated that the amylose forms a gel when mixed with water and intermolecular hydrogen bonds between amylose molecules are formed. These intermolecular hydrogen bonds are thought to stabilize the shape of the composition after cooling. Surprisingly, the inventor of the present invention has found that a very narrow amount of water can be mixed with cooked green banana, thereby obtaining a potato substitute food product that is very much like a real potato food product, such as a French fry or a cooked potato, in terms of texture, taste, colour, and smell.

In one or more embodiments, step b) comprises blending said first composition until said first mixture forms as a solid mass. The mixing operation may preferably be performed by a rotary knife cutter, or the like, to expose the amylose contained in the starch granule. Preferably, step b) comprises blending until said first mixture forms as a solid ball, thereby securing that the first mixture is ready to shape into the desirable shape for the final purpose, such as a potato shape or French fry shape. The rotary knifes are preferably operated at a speed of at least 3000 rounds per minute (rpm), preferably for at least 30 seconds.

In the present context, the term “French fry” is meant an elongated product made predominantly from potatoes. The term “potato substitute” is meant a product, such as cooked potatoes or French fries, that is not made predominantly from potatoes.

In one or more embodiments, the potato substitute food product in step c1) or c2) is formed into a French fry, and wherein said amount of added water is within the range of 15-20% w/w, and more preferably within the range of 16-19% w/w.

In one or more embodiments, the method further comprises the step of d1) freezing, e.g., ultra-freezing, said potato substitute food product.

In one or more embodiments, the potato substitute food product in step c1) or c2) is formed into a cooked potato, and wherein said amount of added water is within the range of 17-22% w/w, and more preferably within the range of 19-21% w/w.

In one or more embodiments, the method further comprises the step of d2) cooking said potato substitute food product. Preferably, the method further comprises the step of e) packaging said cooked products in a water solution, preferably a saline solution, e.g., with added antioxidants, such as ascorbic acid, and citric acid.

A second aspect relates to a potato substitute French fry produced by the method according to the present invention.

A third aspect relates to a potato substitute cooked potato produced by the method according to the present invention.

A fourth aspect relates to a potato substitute produced by the method according to the present invention.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### DETAILED DESCRIPTION OF THE INVENTION

The following description is to be seen as non-limiting examples of potato-like products according to various embodiments of the present invention.

### EXAMPLES

TABLE 1
Formulation and organoleptic characteristics of
the potato-like product as a cooked potato.

| | Wa- | | | | | |
|---|---|---|---|---|---|---|
| Green | ter | Wa- | | | | |
| Plantain | added | ter | Organoleptic characteristics | | | |
| (g) | (g) | (%) | Texture | Taste | Colour | Smell |
| 100 | 0 | 0.0 | Harder | Similar | Darker | Similar |
| | | | than a | to cooked | than a | to cooked |
| | | | cooked | a potato | cooked | a potato |
| | | | potato | | potato | |
| 100 | 10 | 9.1 | Harder | Similar | Darker | Similar |
| | | | than a | to cooked | than a | to cooked |
| | | | cooked | a potato | cooked | a potato |
| | | | potato | | potato | |
| 100 | 20 | 16.7 | Harder | Similar | Darker | Similar |
| | | | than a | to cooked | than a | to cooked |
| | | | cooked | a potato | cooked | a potato |
| | | | potato | | potato | |
| 100 | 24 | 19.4 | Similar | Similar | Similar | Similar |
| | | | to cooked | to cooked | to cooked | to cooked |
| | | | a potato | a potato | a potato | a potato |
| 100 | 27 | 21.3 | Similar | Similar | Similar | Similar |
| | | | to cooked | to cooked | to cooked | to cooked |
| | | | a potato | a potato | a potato | a potato |
| 100 | 30 | 23.1 | Softer | Similar | Similar | Similar |
| | | | than a | to cooked | to cooked | to cooked |
| | | | cooked | a potato | a potato | a potato |
| | | | potato | | | |

TABLE 2
Formulation and organoleptic characteristics
of the potato-like product as a French fry.

| | Wa- | | | | | |
|---|---|---|---|---|---|---|
| Green | ter | Wa- | | | | |
| Plantain | added | ter | Organoleptic characteristics | | | |
| (g) | (g) | (%) | Texture | Taste | Colour | Smell |
| 100 | 0 | 0.0 | Harder | Similar | Darker | Neutral |
| | | | than a | to a | than a | |
| | | | French fry | French fry | French fry | |
| 100 | 10 | 9.1 | Harder | Similar | Darker | Neutral |
| | | | than a | to a | than a | |
| | | | French fry | French fry | French fry | |
| 100 | 20 | 16.7 | Similar | Similar | Darker | Neutral |
| | | | to a | to a | than a | |
| | | | French fry | French fry | French fry | |
| 100 | 24 | 19.4 | Similar | Similar | Intermediary | Neutral |
| | | | to a | to a | to a | |
| | | | French fry | French fry | French fry | |
| 100 | 27 | 21.3 | Softer | Similar | Intermediary | Neutral |
| | | | than a | to a | to a | |
| | | | French fry | French fry | French fry | |
| 100 | 30 | 23.1 | Softer | Similar | Similar | Neutral |
| | | | than a | to a | to a | |
| | | | French fry | French fry | French fry | |

### Example 1

### Determination of the Optimal Conditions for Blending Green Banana/Plantain

The present example relates to optimization of the process step during sample preparation of samples from a mixture to be used in the production of a potato-like product, according to the present invention.

One hundred grams of freshly cooked green plantains were used in a domestic food processor (Bosch, 50-60 hz, 800 W) using the knife tool. The 100 g of cooked green plantain was mixed with increments of water (see Tables 1 and 2) and blended until the formation of a solid ball-like structure.

With the addition of water above 30% it was a mash like consistency and became harder after a certain time at room temperature. The mash-like products could be used in product, which need more water content to give a more closely mouth feel of an actual potato, depending on the final product used.

### Example 2: Moulding of Potato-Like Structures

All resulting pastes were easily mouldable in the shape of typical potato products, such as: French fries (several shapes), hand peeled potatoes, sliced cooked potatoes. It can be placed in moulds or pressed in a different shape as: stars, hearts, etc to appeal to the young consumers.

### Example 3: Comparison of Two Commercially Available Potato Salads and the Potato-Like Product

A tasting of potato substitute was conducted and compared with two commercially available products (ready-made potato salad). The sauce was scraped from the commercial products and tasted in combination with the new developed potato-like product.

The product containing between 15-25% added water had a similar appearance, taste and texture to a regular cooked potato, and it was very pleasant to eat and could be easily confounded with a regular potato. The product from the mix with 20% added water had the highest similarity with the commercially ready-made potato salad.

### Example 4: Comparison of Two Commercially Available Frozen French Fries and the Potato-Like Product in a French Fry's Shape

A tasting of potato substitute was conducted and compared with a commercially avail-able product (frozen French fries). The test product and French fries were deep fried using the same oil and therefore same cooking conditions.

The product containing between 15-25% added water had a similar appearance, taste and texture to a regular cooked potato, and it was very pleasant to eat and could be easily confounded with a regular potato. The product from the mix with 16% added water had the highest similarity with the commercially French fries.

1. A method for the production of a potato substitute food product comprising the steps of:
a) Combining 50-90% w/w of cooked green banana with 10-30% w/w water, and optionally 0-40% w/w of additives, such as flavorings, protein, starch, alpha-amylase inhibitor to form a first composition;
b) Mixing said first composition to form a first mixture;
c1) Filling said first mixture into a container or mold with the shape of a potato food product to form a potato substitute food product; or
c2) Extruding said first mixture into a container or mold with the shape of a potato food product to form a potato substitute food product, or extruding said first mixture directly into a form of a potato substitute food product; and
d1) Optionally, cooling or freezing said potato substitute food product; or
d2) Cooking, roasting, boiling, or frying said potato substitute food product.

2. The method according to claim 1, wherein step b) comprises blending said first composition until said first mixture forms as a solid mass.

3. The method according to claim 1, wherein step b) comprises blending until said first mixture forms as a solid ball.

4. The method according to claim 1, wherein step b) comprises shredding with a rotary knife cutter, preferably to expose amylopectin and amylose from the starch grains present in said green banana.

5. The method according to claim 1, wherein said potato substitute food product in step c1) or c2) is formed into a French fry or formed into a shape that can be cut as a French fry, and wherein said amount of added water is within the range of 15-20% w/w.

6. The method according to claim 5, further comprising the step of d1) freezing, e.g., ultra-freezing, said potato substitute food product.

7. The method according to claim 1, wherein said potato substitute food product in step c1) or c2) is formed into a cooked potato, and wherein said amount of added water is within the range of 17-22% w/w.

8. The method according to claim 7, further comprising the step of d2) cooking said potato substitute food product.

9. A potato substitute French fry produced by the method according to claim 1.

10. A potato substitute cooked potato produced by the method according to claim 1.

11. A potato substitute produced by the method according to claim 1.
